(19) United States
(12) Patent Application Publication
(10) Pub. No.: US 2002/0138747 A1
(43) Pub. Date: Sep. 26, 2002

(54) Restricted data access

(76) Inventor: John Richard Clarke, Clevedon (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/101,498

(22) Filed: Mar. 20, 2002

(30) Foreign Application Priority Data
Mar. 20, 2001 (GB) 0106837.8

(51) Int. Cl. H04L 9/32; G06F 11/30

(52) U.S. Cl. 713/189

(57) ABSTRACT

A data storage medium 10 adapted to restrict access to data 20 stored thereupon by encrypting control login 18, 22 which directs storage devices 62, 64 where to look for the data 20 on the storage medium 10 and a method for providing such a storage medium 10.

### BACKGROUND OF THE INVENTION

1. Field of the Invention

This invention relates to a data storage medium and method for restricting access to data stored on such a medium.

2. Description of Related Art

Current methods of restricting access to data involve the encrypting of data using either asymmetrical, for example public key infrastrutive (PKI), or symmetrical, for example DES, encryption techniques, as shown in FIG. 1. These techniques prevent access of data by persons who do not possess a public key corresponding to that generated by the encryption process.

Encryption of the body of the data stored on media, for example, CDs, DVDs, magnetic disks, tapes, Zip™ disk or ROM's, is becoming more susceptible to being broken as computing power increases. Symmetrical encryption is already considered to be susceptible to compromise, with asymmetrical encryption less so, but asymmetrical encryption and decryption can be many times more computationally intensive to perform than symmetrical encryption/decryption.

The encryption of data does not overcome one fundamental problem with restricting data access which is that once the public key is known it is a trivial exercise to use any data reading device which is compatible with the data storage medium, e.g. a CD player can read all CD's, irrespective of which machine recorded them, a disk drive can read any disk etc, to read the data.

### SUMMARY OF THE INVENTION

It is an object of the present invention to provide a data storage medium storing device, writing device, read/write system, adapted to restrict access to data stored on the medium which, at least partly, ameliorates, at least one of, the above-mentioned problems.

It is a further object of the present invention to provide a method of restricting access to data stored on a medium which, at least partly, ameliorates, at least one of, the above-mentioned problems.

According to a first aspect of the invention there is provided a data storage device having a data storage medium and having subject matter data stored on the storage medium, and also having control data stored on the medium, the control data in use providing information to a reading device to enable the reading device to find and/or read the subject matter data, characterised in that the control data is encrypted such that use of the control data by a reading device is restricted to a reading device adapted to decrypt the control data.

The data storage device may be, for example, a magnetic disk and the data storage medium may be the magnetic material that to which data is written when data is stored on the disk. The data storage device may be a magnetic tape, or an optical CD, or a solid state device such as an EPROM or EEPROM. These are just some examples of storage memory devices.

The subject matter data is of course the data/information to be recorded in the data storage medium—the subject matter of the message or record being stored. The control data may be of two types: medium orientated control data and specific subject matter control data. The medium orientated (or related) control data may be medium-management control data, for example one or more of: data identifying a medium as of a known type, identifying the format used in the medium to store data, other formatting data, when the recording was created, the number of times that data storage device has been written to, when the data storage device, or a particular subject matter data set, was last read (and/or how many times it has been read), etc. The medium-related data may be related to the overall management of the medium or device. The subject matter control data is related to control data for one or more specific subject matter data records, such as for example a directory saying where to find the subject matter data in the data storage.

The data storage medium will usually have on it the subject matter data, as well as the control data. However, it is conceivable that a “blank” data storage device having encoded thereon encrypted control data (medium-related control data) may be provided. Use of such a device would be restricted to data writers which can decode the encrypted medium control data.

The data storage device may be portable. The data storage device may be removable from a reader or writer. The data storage device may, in a non-exhaustive list, be any one of a tape, CD, Zip™ disk, floppy disk, hard disk or any form of ROM or RAM or EPROM. The medium may have a portion or region or segment thereof in which control data is stored. Portion will be taken to mean any one of region, segment or portion. This portion may be an index area or alternatively may be a media control area. The control data may be media control data.

The medium control data may include one or more, in any combination, of: a header, a footer, block addressing, file allocation tables, directories, sequencing information, error correction control data (ECC), device striping control data, bad block tables or media tags. This is not an exhaustive list. Any one or more of the aforesaid may be stored in portion of the medium which is to be dedicated to storing the medium control data. The data may have a subject matter data portion and a media control data portion.

The specific subject matter control data may contain information regarding the location of the subject matter data within the medium, which we will term “subject matter access data”. A reading device not only needs to know medium control data, but also data to enable it to locate and read the subject matter data. For example the subject matter data may be stored in different blocks of data distributed over the data storage medium, not necessarily sequentially on the medium (indeed the data blocks over which the subject matter data is spread will not usually be sequential in the case of random access storage devices). Thus, without the address of the data blocks for the subject matter data, and the order in which they are to be read, a reading device cannot effectively read a data storage device. The specific subject matter control data may therefore include subject matter access data such as a file allocation table, a directory, and sequencing information.

The medium control processing of medium control data that occurs in a reader or writer expects to find subject matter control data, or subject matter control indices, possibly in a predetermined area, and in a predetermined format. The subject matter control data relates to the actual numerical values contained in the subject matter control data/indices (in the directories etc).

The medium control data may have been encrypted by a an encryption process. The encryption may be symmetrical, for example DES or a derivative method. Alternatively, the encryption may be a more secure encryption technique, for example asymmetrical, for example using the public key infrastructive (PKI). It may be significantly slower to encrypt and decrypt using a more secure (e.g. asymmetric) technique.

The medium control data may be encrypted, whether or not the subject matter control data is encrypted. This enables us, for example, to produce a blank data storage device which cannot be used by recording devices which cannot decrypt the medium control data.

More usually, the data storage device will have subject matter data on it and both the medium control data and the specific subject matter control data will be encrypted (possibly requiring a single common decryption key, or for increased security requiring different decryption keys for the two kinds of control data).

It is conceivable that we may encrypt the specific subject matter control data and not the medium control data.

The subject matter data may be encrypted by a different encryption process from that used for the control data. Alternatively, the subject matter data may not be encrypted. The encryption used for the subject matter data may be a faster encryption technique than is used to encrypt the control data, for example it may be a symmetrical encryption technique. The control data and the subject matter data may be encrypted using different encryption keys, and may require different decryption keys to decrypt them. When a PKI infrastructure is used, the private key need to decrypt the control data is required to be known by the reading device in order that the control data can be read from the medium. The private subject matter decryption key (which may be the same or different) may need to be known to the data storage device properly, if the subject matter data is encrypted. However, the subject matter may not be decrypted by the storage device itself, but may instead be decrypted separately e.g. by a host system with access to the relevant private key.

There may be multiple levels (layers) of encryption applied to either or both of the media control data or/and the subject matter data. The level of encryption may be layered.

The encryption may take place in an encryption/decryption device (engine) which may be associated with a write/read system of a data storage apparatus. Pre-encrypted subject matter data may be received by a data read and/or write device.

According to a second aspect the invention comprises a data storage apparatus comprising a data writer and/or a data reader, a controller adapted to control the data writer and/or reader; an encryption and/or decryption engine adapted to encrypt or decrypt data; and either a data storage device, or a data storage device receiving unit adapted to receive a removable data storage device; and wherein the controller is adapted to control the encryption/decryption engine either to (i) decrypt control data of a data storage device which is in accordance with the first aspect of the invention and to read the control data, or to (ii) encrypt control data and write encrypted control data to a data storage device so as to produce a data storage device in accordance with the first aspect of the invention.

There may be a network comprising a plurality of data storage apparatus with at least one of said apparatus being apparatus which is allowed access to the encrypted control data and the subject matter data stored on a data storage device.

According to a third aspect of the invention there is provided a method of restricting access to data stored on a data storage device comprising the steps of:

(i) writing subject matter data to a storage medium;

(ii) generating control data associated with the management of the data stored on the data storage device, and associated with the management of the data storage device itself; characterised by

(iii) encrypting the control data; and

(iv) writing the encrypted control data to the storage medium.

It will be appreciated that steps (i) to (iv) do not have to be performed in the order listed.

The method preferably comprises providing a control data decryption key to read devices that are authorised to read the data storage device. The control and subject matter data may be written to different portions or segments of the data storage device.

The method may further include the step of storing the control data decryption key on a read device, or entering the decryption key into a read device, to adapt the read device, in use, to be capable of reading encrypted control data.

The method may include the step of encrypting the subject matter data. There may be a private key associated with an encrypted subject matter data segment and capable of being used to decrypt encrypted subject matter data. The subject matter decryption key may be stored on a read device.

The decryption key may be electronically, manually, or otherwise stored, possibly permanently stored, with a read device, or it may be provided to the read device at the time of decrypting (e.g. a user or other machine may input the decryption key to enable the device to decrypt the control data and/or subject matter data). The method may include the step of utilising the control data decryption key to decrypt the control data.

The method may also include the step of using the decrypted control data to locate the, possibly encrypted, subject matter data within the data storage medium. The method may further include the step of using the encrypted subject matter data.

The method may further include the step of decrypting the subject matter data by using a read device which uses a subject matter decryption key associated with the encrypted subject matter data.

The decryption key(s), which may be private keys of a PKI system, may be stored remotely from the read device and may only be passed to it when required to decrypt the control and/or subject matter data. The keys(s) may be stored on a secure piece of firmware or on a secure storage device. The encryption of either or both of the subject matter and control data may be either symmetrical or asymmetrical encryption. There may be repeated, layered encryptions of either or both of the control data and subject matter data.

According to a fourth aspect of the invention there is provided a method of restricting access to data stored on a medium comprising the steps of:

i) providing a data storage device having a data storage medium containing subject matter data and encrypted control data;

ii) decrypting the control data so as to enable a reader to use the data storage device and to find the address of subject matter data in the data storage medium;

iii) using the decrypted control data to locate the subject matter data in the medium; and

iv) reading the subject matter data from the medium.

The subject matter data may also be encrypted. The method may further include the step of decrypting the subject matter data possibly after step (iv).

It will be appreciated that steps (i) to (iv) do not have to be performed in the order listed, but in this case (read), they probably do.

According to a fifth aspect of the invention there is provided a method of restricting access to data stored on a medium comprising the steps of the third and fourth aspects of the present invention.

According to a sixth aspect of the invention there is provided a computer readable medium having a program recorded thereupon which causes, in use, a processor, storage device or computer running the program to execute a method according to any one of the third, fourth, or fifth aspects of the present invention.

According to a seventh aspect of the invention there is provided a computer readable medium having a program thereupon which causes a read device running the program to a execute a process which adapts the read device to be able to read a device according to the first aspect of the present invention, or to cause the read device to be a device in accordance with the second aspect of the invention.

According to an eighth aspect of the invention there is provided a data writer adapted to write data to a data storage medium of a data storage device, the writer having a data writing head and a controller controlling the data controlling head, the control being adapted to receive subject matter data to be stored on the medium and to create control data to accompany the subject matter data, the control data providing information adapted to enable a reading device to use the data storage device and to locate and read the subject matter data on the medium, and in which the writer is adapted to encrypt the control data before writing it onto the medium.

The writer may be adapted to write the subject matter data in a disjointed, fragmented, form at different physical places on the medium.

Preferably the writer is adapted to write the control data, or a pointer to the control data, to a predetermined place in the medium.

Writing the subject matter data to fragmental, disjointed, parts of the medium makes it difficult for a reader to read and make sense of the subject matter data if it does not know where the fragments and, and in what order they should be read/collected together or re-ordered. Writing the control data to a predetermined known place makes it easy for a reader to find the “map” of directions on how to find and use the subject matter data. Encrypting the “map” makes it difficult to used it without the encryption key.

The subject matter data may be encrypted before it is written. It may be encrypted at the writer device, or it may be pre-encrypted before it is sent to the writer for writing.

According to a ninth aspect of the present invention there is provided a reader adapted to read a compatible data storage device, the data storage device having a data storage medium having subject matter data stored in it, and control data stored in the data storage medium, the control data, when read, enabling a reader to find and read the subject matter data in a meaningful way, the control data of the data storage medium being encrypted; in which the reader has a read head and a controller, the controller directing the read head to read the medium, or a predetermined region of the medium, to read the control data, and the controller being adapted to decrypt the control data, to access the control data, and to use the control data to direct the read head to read the subject matter data, in use.

According to a tenth aspect of the present invention there is provided a method of writing data to a data storage medium comprising the steps of:

(i) providing a writer having a data writing head;

(ii) receiving subject matter data at the writer;

(iii) writing the subject matter data to the data storage medium;

(iv) creating control data indicative of the data medium formatting and of the location of the subject matter data on the data storage medium;

(v) encrypting the control data; and

(vi) writing the encrypted control data to the data storage medium.

It will be appreciated that steps (i) to (vi) may not be performed in the listed order.

According to an eleventh aspect of the present invention there is provided a method of reading data from a data storage medium comprising the steps of:

(i) providing a reader having a read head and a controller;

(ii) directing the reader where to find encrypted control data on the data storage medium;

(iii) accessing the encrypted control data;

(iv) decrypting the control data; and

(v) utilising the control data to direct the read head to read subject matter data.

Again, it will be appreciated that steps (i) to (v) may not necessarily be performed in the sequence given, but in most cases they will follow this order.

### BRIEF DESCRIPTION OF THE DRAWINGS

The invention will now be described, by way of example, with reference to the accompanying drawings, of which:

FIG. 1 is a flow diagram showing a prior art method of restricting access to data stored on a medium;

FIG. 2 is a schematic diagram of a data storage disk;

FIG. 3 is a schematic representation of a block of data on a tape;

FIG. 4 is a schematic representation of a data encryption arrangement according to the present invention;

FIG. 5 is a flow diagram showing a method of storing data on a medium so as to restrict access thereto, according to an aspect of the present invention;

FIG. 6 is a flow diagram showing a method of storing data on a medium so as to restrict access thereto, according to an aspect of the present invention;

FIG. 7 is a schematic representation of a plurality of data reading devices connected to a network.

FIG. 8 is a schematic representation of a data storage type in accordance with the invention; and

FIG. 9 shows more detail of pat of FIG. 8.

### DESCRIPTION OF A PREFERRED EMBODIMENT

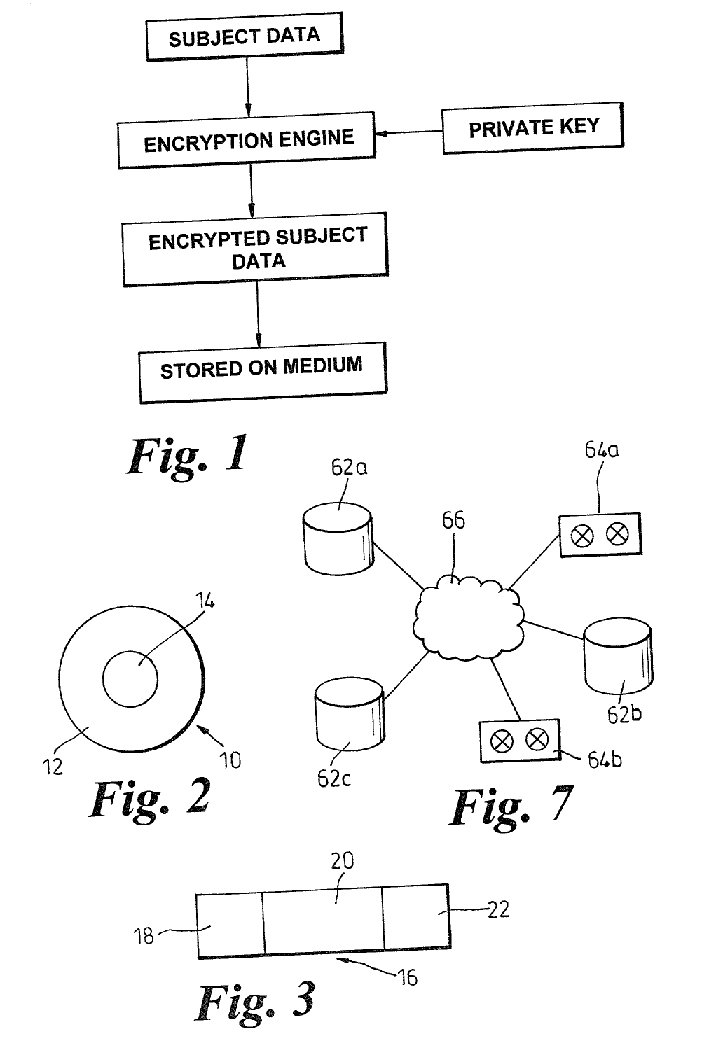

FIG. 1 shows that it is known to encrypt subject data (data about a subject to be stored and retrieved later) and to store encrypted data.

FIG. 2 shows a conceptual embodiment which has a data storage device 10 having a main subject matter data storage portion 12 of its data storage medium and a media control data storage portion 14 of its data storage medium. The storage device 10 can be of any convenient form, for example, a magnetic disk, an optical disk such as a CD or DVD, a magneto-optical disk, a Zip™ disk, a tape, or a read only memory (ROM) device.

FIG. 3 shows, conceptually, a tape having a data block 16 comprising control data including a header segment 18, a body, or subject matter, segment 20 and a footer segment 22 (also part of control data). The header 18 and footer 22 include storage system and media management control data which is associated with accessing in general, and of subject matter-specific control data associated with accessing specific subject matter data held on the data storage device 10. The subject matter segment 20 contains the bulk of the information to be stored, the content that is desired to be retrieved later.

The storage system and media control management data may include, as a non-exhaustive list, any one or combination of media header and trailer data, data block addressing, file allocation tables, directories, block length data, sequencing information, error correction control data (ECC), device striping control data, bad blocks tables or media logs.

The storage system and media control data, and the specific subject matter control data, may reside in the header or the footer or in both.

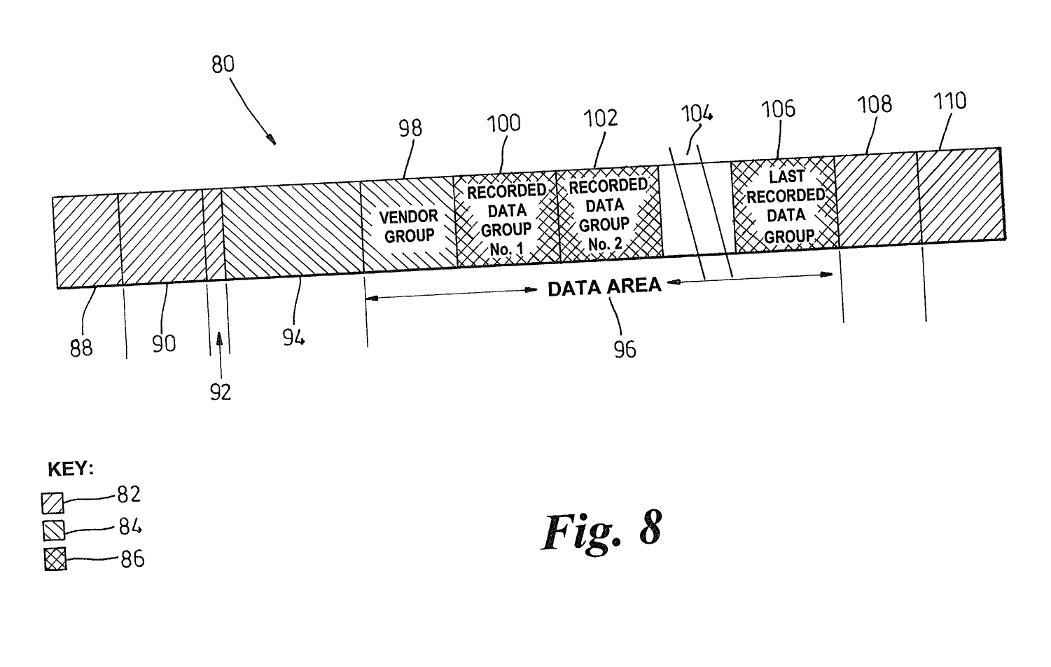

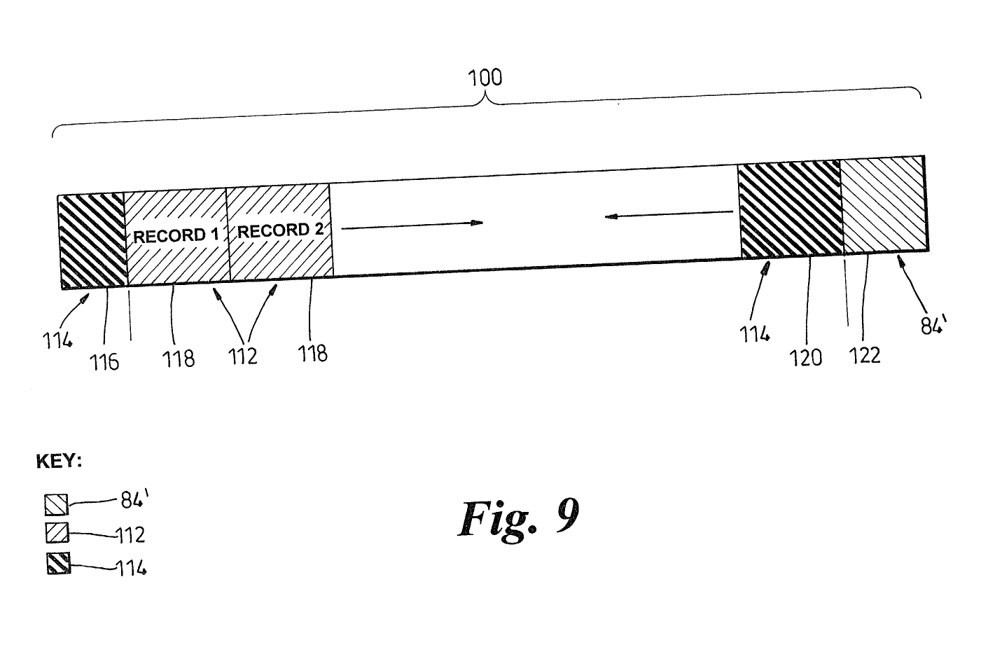

Alternatively the control data can reside in another ‘directory’ area of the data storage medium. The exact control data stored in the header and footer 18, 22 will depend upon the data storage medium employed. FIGS. 8 and 9 show an example in more detail.

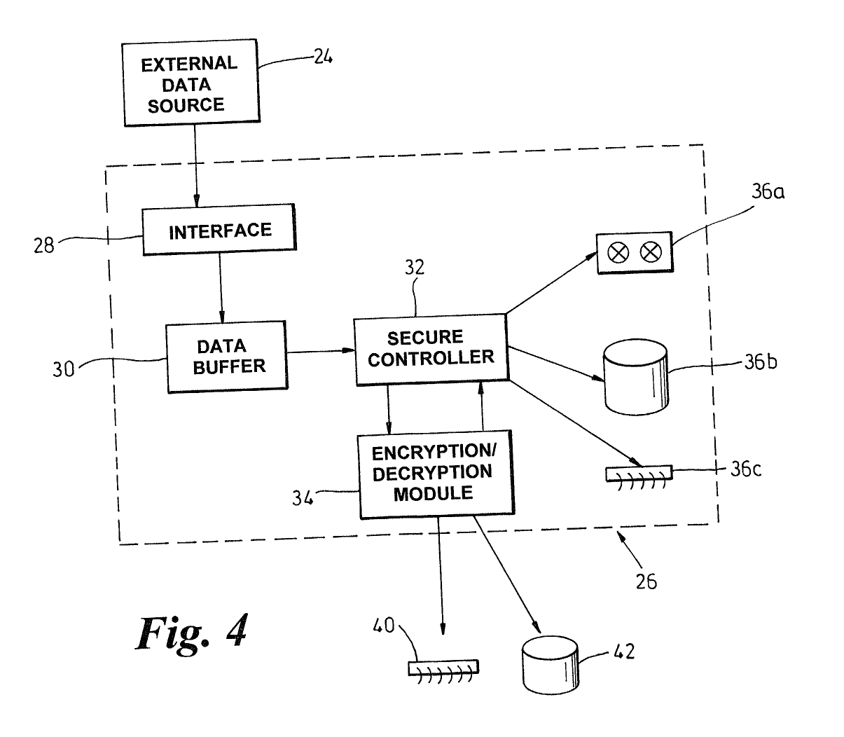

In an embodiment of the present invention, shown in FIG. 4, data blocks 16 from a data source 24 are passed into a data recording apparatus 26. The data storage apparatus 26 comprises an interface 28, a data buffer 30, a secure controller 32 with an associated encryption/decryption module 34 and removable data storage devices 36a, 36b, 36c.

The subject matter segment 20 of the data blocks 16 from the external data source 24 may or may not be encrypted prior to being passed into the data recording apparatus 26. If the subject matter segment is not encrypted prior to entry into the apparatus 26 it can be encrypted by the encryption/decryption module 34 if desired. The external data source 24 may be, for example, a LAN, the Internet, a PC or a server.

The interface 28 serves to establish a communication path and to ensure interoperability and consistent data handling between different data sources 24 and the data storage apparatus 26. The interface 28 may take the form of, for example, an internal bus, SCSI or FiberChannel interface.

The data buffer 30 maintains a steady and consistent data transfer rate to the controller 32. The buffer 30 is typically a piece of memory.

The secure controller 32 controls the formatting and preparation of data blocks 16, prior to their recording on the data storage devices 36a, 36b, 36c. This can include blocking and compression of the data. Any data block 16 may have a flag which is recognised by the controller 32 as indicating that the control data generated upon recording the subject matter data 20 content to the main storage portion 12 of the devices 36a, 36b, 36c, is to be encrypted. The presence of such a flag results in the control data being passed to the encryption/decryption module 34. The subject matter data 20 is broken up and stored at a series of discrete locations in the data storage medium of the devices 36. It is the control data which contains the information detailing where these subject matter data fragments are stored. The encrypted control data is subsequently recorded into the control data storage portion 14 of the storage devices 36a, 36b, 36c. It will be appreciated that the subject matter data 20 need not be broken up at all, or it could be broken up into separate portions, the data within a particular portion being written and stored contiguously in the data storage medium. Each portion into which the subject matter data is broken may be relatively small in comparison with the whole of the subject matter data of a data record (e.g. ¼, 1/10, 1/100, 1/1000, 1/10000, or less).

A private decryption key associated with the encryption of the control data is, in one embodiment, passed to either a piece of secure firmware 38 or a secure data storage medium 40 separate from the media 36a, 36b, 36c. In other embodiments other decryption key handling techniques may be used to ensure secure storage and communication of decryption keys.

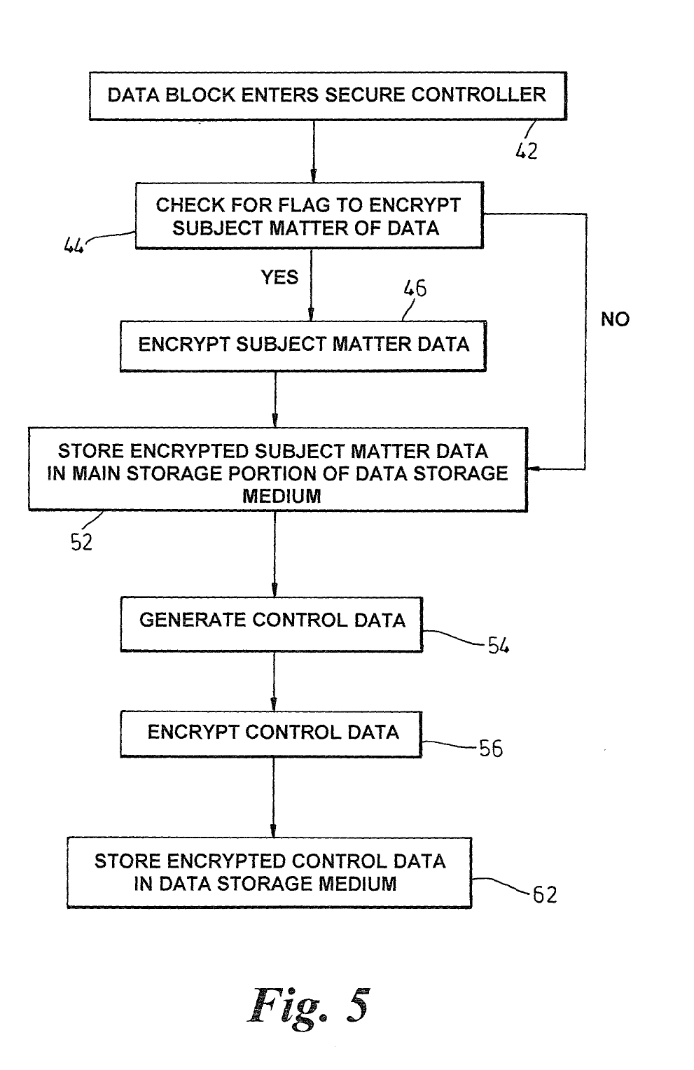

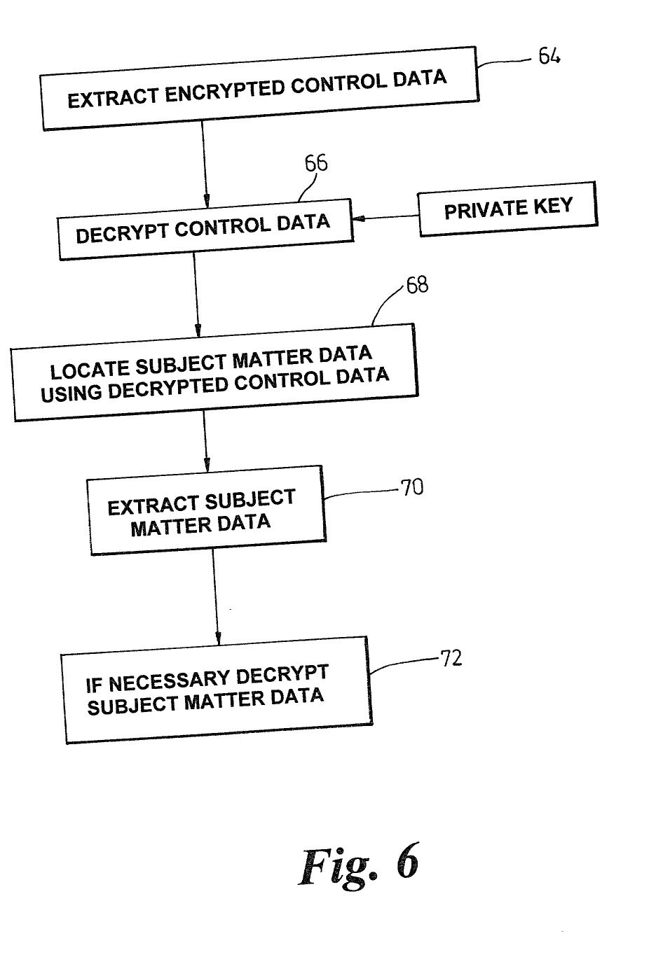

FIG. 5 shows a flow diagram for the encryption of a subject matter data block 16. Initially the subject matter data block 16 enters the secure controller 32 from the buffer 30 (step 42). The secure controller 32 then examines the subject matter data block 16 to see if a flag is set to encrypt the subject matter data block 16 (step 44). If the flag is set to encrypt the data block 16 the subject matter data 20 is encrypted (step 46) using either symmetrical encryption (DES or derivative method) or preferably asymmetrical encryption (PKI). The flag may have different settings for whether symmetric or asymmetric encryption is to be used. Asymmetrical encryption is preferred, at least for the encryption of the control data, as it is harder to crack, despite being more intensive in computational overhead. (i.e. slower). Encrypting the, smaller sized, control data asymmetrically and encrypting the larger volume of subject matter data symmetrically may have attractions in certain applications.

It will be appreciated that the method shown in FIG. 5 is not the only way of encrypting a subject matter data block. For example, a separate command, e.g. a SCSI command or other configurational switch (e.g. a hardware switch), may be used to encrypt the subject matter data.

A private subject matter decryption key is associated with the encrypted subject matter data and this may be stored in secure firmware or a secure data storage device, or it may be input (e.g. typed in) by a user.

The encrypted subject matter data 20 is stored in the main storage portion 12 of the data storage device 10 (step 52). If the flag is not set to encrypt the data block 16 the unencrypted subject matter data 20 is stored in the main storage portion 12 of the data storage device.

Control data information relating to the location of the subject matter data 20 within the main storage portion 12, and information as to the formatting and storage system and media control/management control data contained within the header 18 and footer 22 is used to control how the device 10 is read (step 54). The control data (specific subject matter control data and medium-related control data) is encrypted (step 56) either using the same encryption algorithm as the subject matter data encryption (46) or a different algorithm.

It is necessary to store the control data decryption key, or at least enable the decryption key to be entered. The decryption key may in some examples be stored either on a piece of secure firmware or a secure storage device. The firmware or data storage device could be the same device as that upon which the subject matter data encryption key is stored, or alternatively may be a different piece of firmware or a different data storage device. Alternatively a user may enter the decryption key. This enhances the security of the system as two pieces of equipment must now be compromised or hacked in order to obtain the two decryption keys.

The encrypted control data is then stored in the media control portion of the data storage device (step 62).

In a data-reading operation the subject matter data 20 is recovered by locating and extracting the encrypted control data (step 64). The control data decryption key is then used to decrypt the control data (step 66). The decrypted control data is used to locate subject matter data on the storage medium (step 68) and to instruct a reader device how to use the data storage device/how to interface with it. The subject matter data is extracted from the storage medium (step 70) and decrypted, if necessary (step 72).

It is in the invention necessary to have the control data decryption key in order to decrypt the control data to be able to use the data storage device. This therefore adds a layer of security not previously achieved.

Each private decryption key may have a certificate issued by an independent Certification Authority which verifies its authenticity. These certificates have a finite, defined duration in order to limit the opportunity for hacking.

In order to prevent old private keys being compromised, or in the case of expiry of a certificate, the control data and/or subject matter data may be decrypted and re-encrypted using a new key from time to time (or held in multiple layers of encryption).

Thus, it will be necessary to know the current decryption key to access the control data, and if held in multiple layers of encryption, all of the decryption keys.

Alternatively, the control data and/or the subject matter data could be decrypted and re-encrypted using a new private and public key. The private keys may be stored somewhere, possibly internally of the read and/or write device, possibly inside or associated with the read and/or write device. When the private key(s) are required by the storage device they (or it) can be passed from a separate secure storage device when access to previously stored data is required.

The invention allows selective enablement of data storage devices of a particular class and inhibits the access of data stored on data storage devices by readers which are not enabled (do not have the decryption key for the control data).

This is exemplified by the arrangement shown in FIG. 7. A plurality of data storage apparatus, e.g. disk drives 62a, 62b, 62c and tape drives 64a, 64b are connected together via a network 66.

Data stored on the network 66 in, for example, a disk or drive 62a, using the present invention cannot be accessed if the disk is transferred to drive 62b unless drive 62b supplied with the control data decryption.

FIG. 8 shows a magnetic data storage tape 80, in this example of DDS-3 tape format. It is not recommended to use the encryption methodology of the present invention for the information contained in area 82. Areas 84 contain media control data that is, or may be, encrypted using the methodology of the invention. Areas 86 contain media control data, subject matter access data and subject matter data which is, or may be, encrypted using the methodology of the invention. The key shown in FIG. 8 illustrates these areas.

The tape 80 is that of the ECMA standard ECMA-236 ″3.81 mm wide magnetic tape cartridge for Information Interchange—Helical Scan Recording—DDS-3 Format, using 125 m length tapes. Further information on this type of tape can be found at the ECMA website at www.ecma.org, the contents of which are hereby incorporated by reference (the skilled reader of course knows what is on that website, and knows of the DDS-3 tape format). Portions of the tape are reserved for data associated with specific functions.

Portion 88 is a device area which is an area of the device which passes a read head during spinning up of the device/tape to its operating speed, and this area of the tape is not used for writing any media control data or subject matter data: it is a lead-in area at the physical beginning of the tape ahead of the logical beginning of the tape. Portion 90 is a reference area which is a part of the tape which helps the device that is using the tape to have a reference point on the tape, and to help it to find the system area of the tape, and the system log in the system area (see later). Portion 92 is position tolerance band No.1 which is an area of the tape used to accommodate positional tolerances when updating the system log, and does not contain any specific subject matter data or media control data. Portion 94 is a system area which is a section of the tape which contains tape usage information and some media control information, for example it typically contains a history of tape usage such as the number of times the tape has been used, the number of errors produced when running the tape, the number of times it has been retried, and it may contain information on the number of Record Data Groups that will be found on the tape. Portion 96 is a data area which contains subject matter data being stored and has a vendor group sub area 98, recorded data group 1 and recorded data group 2, 100 and 102, for different recorded groups of subject matter data, subsequent recorded data group areas 104, and a last recorded data group area 106. The tape also has an EOD area 108 and a post-EOD area 110.

The vendor group area 98 contains vendor specific information not defined by the tape format, for example subject matter control data and media control data (not defined by the tape format per se). It does not contain subject matter data per se. The recorded data group No. 1, referenced 100, contains, of course, a Data Group that has been recorded onto the tape in that area. FIG. 9 shows in more detail the structure of a Data Group record. Subsequent Data Groups are recorded along the tape.

The EOD area 108 is a marker marking the End of Data: beyond this point there is no more data. The post EOD area 110 is blank tape to the physical end of the tape.

It will be appreciated that the subject matter data (probably encrypted, but not necessary) is in area 96, the medium control data (encrypted) is in the system area 94 and vendor groups area 98.

FIG. 9 shows more detail of a recorded data group of FIG. 8, say for the sake of example recorded Data Group 1, referenced 100. The recorded Data Group area 100 has areas 84 which contain media control data that is, or may be, encrypted, areas 112 which contain subject matter data that is or may be encrypted; and areas 114 which contain subject matter access control data that is, or may be, encrypted. The shading for these are shown in the key on FIG. 9.

Within each data group record (100, 102, 104, 106) there is an entity header 116 which is a section of the Data Group area of the tape which has details about the Data Group entity itself, such as how much data is in the Data Group, the length of the entity header itself, how many access points (start points) there are in the Data Group, the length of the subject matter data part of the tape in the Data Group, and how many records there are. The Data Group record 100 also has 1 to n processed records (e.g. record 1 and record 2 referenced as 118 in FIG. 9—these are the actual specific subject matter data entries); a block access table 120 which lists the record addresses for each record in the recorded data group, and entries for the entity header, separation marks (to separate records), other index marks, the format, the length, start, and end of each record, which record in an entity is stored where on the tape, jump ahead data etc; and a group information table 122 which also has record separation data, the count of separators, the count of records, data on the structure of the subject matter data, etc.

It will be appreciated that the subject matter data is in the data records 1 to n, and the media control data is in the group information table, and the subject matter access control data is in the entity header and block access table, at least some of the control data (media control or subject matter access control) being encrypted, and possibly all of the control data being encrypted. The subject matter data may or may not be encrypted.

It is envisaged that the body data segment 20 may not be encrypted and encryption of the control data alone will result in an additional degree of security as it is not possible easily to find the body data segment on a storage medium without the decrypted control data. Moreover, if the medium control data cannot be read the reader cannot use the data storage device. It will become increasingly difficult to accidentally access specific subject matter data as storage capacities increase, for example with the advent of TB hard disks.

It will be appreciated that in essence the invention comprises encrypting control data necessary for a reader to read the subject matter data from a data storage device. The invention separates, in concept, the encryption of the “how to use this data storage device” control data from the subject matter, stored information content, encryption (if it is performed at all).

It will also be appreciated in many instances it is necessary or usual to re-write control data after use of a data storage device. The data formatting information may be re-written from time to time, as may the medium-specific control data.

In a data storage device which has control data at different regions (e.g. in a header and footer) it is possible to use different control data encryption keys for different regions of control data. Indeed, when different blocks of data each have their own associated control data (e.g. header and footer) it is conceivable to have different encryption keys for different data blocks, even though the different data blocks are part of the same overall body of data. A method of indexing individually encrypted blocks to their respective decryption keys would, of course, be needed.

It may be desirable to have the writer/control data change the size of a block of data that is stored as a block of the data storage device, or to re-order the contents of a stored data block (e.g. swap the header and footer over). This “scrambling” of the data blocks assists in restricting the number of devices with which the data storage devices can be used: they can only be used with devices which know how to unscramble them. The invention has particular interest when used with removable data storage devices.

1. A data storage device having a data storage medium and comprising subject matter data stored on said medium, and also having control data stored on said medium, said control data, in use, providing information to a reading device, said control data enabling said reading device to find said subject matter data, wherein said control data is encrypted such that use of said control data by a reading device is restricted to a reading device adapted to decrypt said control data.

2. A device according to claim 1 wherein said control data enables said reading device to read said subject matter data.

3. A device according to claim 2 which comprises a removable data storage device adapted to be introduced into said reading device for reading of said subject matter data and removed therefrom.

4. A device according to claim 1 wherein said control data is of at least two types: a first type comprising medium related control data, and a second type comprising specific subject matter control data.

5. A device according to claim 1 which has a portion thereof in which said control data is stored, and a portion thereof in which said subject matter data is stored.

6. A device according to claim 1 wherein said control data comprises medium control data including at least one of the following: a header; a footer; block addressing; file allocation tables; directories; sequencing information; error correction control (ECC) data; device striping control data; bad block tables; media tags.

7. A device according to claim 1 wherein said control data comprises specific subject matter control data which contains information regarding a location of said subject matter data within said medium.

8. A device according to claim 1 wherein said control data is encrypted asymmetrically and said subject matter data is encrypted symmetrically.

9. A method of restricting access to subject matter data stored on a data storage device comprising the steps of:
(i) writing said subject matter data to a storage medium;
(ii) generating control data associated with management of said subject matter data stored on said data storage device, and associated with management of said data storage device;
(iii) encrypting said control data; and
(iv) writing said encrypted control data to said storage medium.

10. The method of claim 9 including writing said control data and said subject matter data to different portions of said data storage device.

11. The method of claim 9 including encrypting said subject matter data.

12. The method of claim 9 including decrypting control data and locating said subject matter data within said data storage medium using said decrypted control data.

13. A method of restricting access to data stored on a data storage medium comprising the steps of:
(i) providing a data storage device having a data storage medium containing subject matter data and encrypted control data;
(ii) decrypting said control data so as to enable a reader to use said data storage device and to find an address of said subject matter data in said data storage medium;
(iii) using said decrypted control data to locate said subject matter data in said medium; and
(iv) reading said subject matter data from said medium.

14. The method of claim 13 including providing said control data in the form of medium related control data and subject matter control data.

15. The method of claim 13 including decrypting encrypted subject matter data stoned upon said medium.

16. A data writer adapted to write data to a data storage medium of a data storage device, said writer having a data writing head and a controller, said controller controlling said data writing head, in use, and said controller receiving in use subject matter data to be stored on said medium; and being adapted to create control data to accompany said subject matter data, said control data providing information to enable a reading device to use said data storage device and to locate and read said subject matter data on said medium, in use, and wherein said writer is adapted to encrypt said control data prior to said control data being written to said medium.

17. A writer according to claim 16 which is adapted to write said subject matter data in a fragmented form at different physical locations on said medium.

18. A writer according to claim 16 wherein said writer writes said control data, to a predetermined location in said medium, in use.

19. A writer according to claim 16 wherein said writer writes a pointer to said control data located to a predetermined location in said medium, in use.

20. A writer according to claim 16 wherein said subject matter data is encrypted prior to being written to said data storage medium.

21. A reader adapted to read a compatible data storage device, said data storage device including a data storage medium, said medium having subject matter data and encrypted control data stored therein, said encrypted control data, when read and decrypted, enabling said reader to find and read said subject matter data in a meaningful way, and wherein said reader has a read head and a controller, said controller, in use, directing said read head to read a predetermined region of said medium in order to read said encrypted control data, and said controller being adapted to decrypt said encrypted control data to access said control data, and to use said control data to direct said head to read said subject matter data.

22. A method of writing data to a data storage medium comprising the steps of:
(i) providing a writer having a data writing head;
(ii) receiving subject matter data at said writer;
(iii) writing said subject matter data to said medium;
(iv) creating control data, indicative of data medium formatting of, and of a location of said subject matter data on said medium;
(v) encrypting said control data; and
(vi) writing said encrypted control data to said medium.

23. A method of reading data from a data storage medium comprising the steps of:
(i) providing a reader having a read head;
(ii) directing said reader where to find encrypted control data on said medium;
(iii) accessing said encrypted control data;
(iv) decrypting said encrypted control data; and
(v) utilising said control data to direct said read head to read subject matter data.

24. A computer readable medium having a program recorded thereupon for use with a data writer adapted to write data to a storage medium of a data storage device, said data writer having a data writing head and a controller controllable by said program; wherein said program controls said data writing head, in use, and said controller receiving subject matter data to be stored on said medium; and said program creating, when run, control data to accompany said subject matter data, said control data providing information to enable a reading device to use said data storage device and to locate and read said subject matter data on said medium, and in which said program is adapted to encrypt said control data and to cause encrypted control data to be written to said medium.

25. A computer readable medium having a program recorded thereupon for use with a reader having a read head and a controller and being adapted to read a compatible data storage device, the data storage device including a data storage medium, said medium having subject matter data and encrypted control data stored therein, said encrypted control data, when read and decrypted, enabling a reader to find and read said subject matter data in a meaningful way, wherein said program when run causing said read head to read a predetermined region of said medium in order to read said encrypted control data, and said program causing decryption of said encrypted control data to access said control data, and using said control data to direct said head to read said subject matter data.

26. A computer readable medium having a control data decrypt program recorded thereupon which causes, in use, a reader to be able to read a data storage device, said data storage device comprising a data storage medium and comprising subject matter data stored on said medium, and also having control data stored on said medium, said control data, in use, providing information to said reader to enable said reader to find said subject matter data, wherein said control data is encrypted such that use of said control data by said reader is possible after said control data decrypt program has decrypted said control data.

27. A computer readable medium having a program recorded thereupon which causes, in use, a data writer to execute a method of restricting access to subject matter data stored on a data storage device comprising the steps of:
(i) writing said subject matter data to a storage medium;
(ii) generating control data associated with management of said subject matter data stored on said data storage device, and associated with management of said data storage device;
(iii) encrypting said control data; and
(iv) writing said encrypted control data to said storage medium.

28. A computer readable medium having a program recorded thereupon which causes, in use, a data reader to execute a method of restricting access to data stored on a data storage device having a data storage medium containing subject matter data and encrypted control data, said method performed by said program comprising:
(i) decrypting said control data so as to enable a reader to use said data storage device and to find an address of subject matter data in said data storage medium;
(ii) using said decrypted control data to locate said subject matter data in said medium; and
(iii) reading said subject matter data from said medium.

29. A computer readable medium having a program recorded thereupon which causes, in use, a data writer having a data writing head to execute a method of writing data to a data storage medium comprising the steps of:
(i) receiving subject matter data at said writer;
(ii) writing said subject matter data to said medium;
(iii) creating control data, indicative of data medium formatting of, and of a location of said subject matter data on, said medium;
(iv) encrypting said control data; and
(v) writing said encrypted control data to said medium.

30. A computer readable medium having a program recorded thereupon which causes, in use, a data reader having a read head to execute a method of reading data from a data storage medium comprising the steps of:
(i) directing said reader where to find encrypted control data on said medium;
(ii) accessing said encrypted control data;
(iii) decrypting said encrypted control data; and
(iv) utilising said control data to direct said read head to read subject matter data.

31. A data storage device having a data storage medium and comprising subject matter data stored on said medium, and also having control data stored on said medium, said control data, in use, providing information to a reading device, said control data enabling said reading device to find said subject matter data, said control data comprising specific subject matter control data which contains information regarding a location of said subject matter data within said medium, said control data being encrypted such that use of said control data by a reading device is restricted to a reading device adapted to decrypt said control data, and said medium having a portion thereof in which said control data is stored, and a portion thereof in which said subject matter data is stored.

32. A data storage device having a data storage means and comprising subject matter data stored on said storage means, and also having control data stored on said storage means, said control data, in use, providing information to data reading means, said control data enabling said data reading means to locate said subject matter data, said control data being encrypted such that use of said control data by said data reading means is restricted to data reading means adapted to decrypt said control data.
